(19) United States
(12) Patent Application Publication
(10) Pub. No.: US 2023/0284679 A1
(43) Pub. Date: Sep. 14, 2023

(54) SMOKING PIPE

(71) Applicant: Juggernaut Tactical, Inc., Orange, CA (US)

(72) Inventor: Zackary Kasanjian-King, Corona, CA (US)

(73) Assignee: Juggernaut Tactical, Inc., Orange, CA (US)

(21) Appl. No.: 18/119,580

(22) Filed: Mar. 9, 2023

Related U.S. Application Data
(60) Provisional application No. 63/318,897, filed on Mar. 11, 2022.

(51) Int. Cl. A24F 3/00; A24F 1/16; A24F 5/00

(52) U.S. Cl. CPC A24F 3/00; A24F 1/16; A24F 5/00; H01F 7/02

(57) ABSTRACT

A smoking pipe has upper and lower body portions removably magnetically connected to each other. The upper and lower body portions define an enclosed smoke chamber with the upper portion defining a receptacle. A plurality of openings communicate between the receptacle and the smoke chamber and the combined body portions define a passage between the smoke chamber and an outlet. The upper body portion has a planar lower surface and the lower body portion has a planar upper surface, and the upper body portion and lower body portion abut each other in a common interface plane. The upper body portion and lower body portion are detachable by sliding on the interface plane. The passage encompasses the smoke chamber and includes an arcuate portion encircling the smoke chamber including an opposite side of the smoke chamber, and the passage includes an enlarged portion configured to receive a filter.

### CROSS-REFERENCE TO RELATED APPLICATIONS

This application claims the benefit of U.S. Provisional Pat. Application No. 63/318,897, filed on Mar. 11, 2022, entitled “SMOKING PIPE”, which is hereby incorporated by reference in its entirety for all that is taught and disclosed therein.

### FIELD OF THE INVENTION

The present invention relates to pipes for various smoking materials and capable of connection to common accessories used for smoking resinous materials, gels, and smoking products other than minced plant matter.

### BACKGROUND AND SUMMARY

Pipe smoking usually involves providing an apparatus for drawing smoke-laden air into the lungs after this air has passed through a combustion zone where plant matter or other materials are burned so as to release combustion products which are pleasant in taste or aroma or both, and which may impart medicinal or therapeutic effects to the smoker. Modern smoking pipes and accessories include filter chambers for renewable or disposable filters, and basins or chambers where smoke is passed in contact with water or other fluids as a treatment or for cooling the smoke, or for trapping within the fluid precipitates or certain solids from the smoke chamber and passing the scrubbed smoke to the user.

Although smoking, with or without water bowls predated the recorded histories of many cultures around the world, smoking continues to present chores such as cleaning the pipe bowl and restricted passageways of the equipment and other accessories used, and exchanging or refurbishing filters retained within the pipe. The residues from smoking materials are usually resistant to removal by soaps or common cleaning solvents and often require mechanical scrubbing, which also means that pipe users prefer designs affording access to the smoke passageways for cleaning tools.

The above challenges are addressed by a smoking pipe having upper and lower body portions removably magnetically connected to each other. The upper and lower body portions define an enclosed smoke chamber with the upper portion defining a receptacle. A plurality of openings communicate between the receptacle and the smoke chamber and the combined body portions define a passage between the smoke chamber and an outlet.

The upper body portion has a planar lower surface and the lower body portion has a planar upper surface, and the upper body portion and lower body portion abut each other in a common interface plane. The upper body portion and lower body portion are detachable by sliding on the interface plane. The passage encompasses the smoke chamber and includes an arcuate portion encircling the smoke chamber including an opposite side of the smoke chamber, and the passage includes an enlarged portion configured to receive a filter.

### BRIEF DESCRIPTION OF THE DRAWINGS

FIG. 1 shows an oblique, top left rear view of conjoined upper and lower body portions of a smoking pipe in accordance with the invention.

FIG. 2 shows a top view of the smoking pipe of FIG. 1 and defines section line A-A for the cross section views of FIGS. 5A and 6B, and section line B-B for the cross section view of FIG. 5B.

FIG. 3A shows an oblique, bottom left rear view of the smoking pipe of FIG. 1 and an accessory which is a bowl extender exploded away from its installed position.

FIG. 3B shows an oblique, top left rear view of the smoking pipe of FIG. 1, with an airflow adjusting device exploded away from a threaded orifice of the lower body portion into which it is receivable.

FIG. 4A shows a bottom view of an upper body portion of the smoking pipe of FIG. 1.

FIG. 4B shows a top view of a lower body portion of the smoking pipe of FIG. 1.

FIG. 5A shows a cross section view of the conjoined upper and lower body portions of the assembled smoking pipe of FIG. 1 taken at section line A-A defined in FIG. 2.

FIG. 5B shows a cross section view of the conjoined upper and lower body portions of the assembled smoking pipe of FIG. 1 taken at section line B-B defined in FIG. 2.

FIG. 6A shows an oblique, top left rear view of the smoking pipe of FIG. 1 with the airflow adjusting device of FIG. 3B exploded away from the lower body portion and with an adapter for mounting accessories using standardized tapered ground glass joint interconnections.

FIG. 6B shows a cross section view of the conjoined upper and lower body portions of the assembled smoking pipe of FIG. 1 taken at section line A-A defined in FIG. 2 and also includes a glass tube attachment accessory affixed to the accessory connection port atop the upper body portion.

### DETAILED DESCRIPTION OF A PREFERRED EMBODIMENT

The invention is a smoking pipe comprising an assembly of parts which hold together by magnetic force and are easily separable to expose inner passageways for cleaning and for replacing a filter or flavor element used while smoking. The pipe assembly has an ornamental and aesthetic form and may be used in traditional manners of smoking or while using recently developed and modern smoking accessories. The upper and lower sections are attached together using magnets and optionally pins as well, and may be easily separated for complete access to the interior of the pipe for easy and thorough cleaning and quick re-assembly without the use of tools.

Referring now to the figures, FIG. 1 shows an oblique, top left rear view of conjoined upper and lower body portions of a smoking pipe in accordance with the invention. The pipe assembly [10] comprises an upper body portion [1] magnetically attached to a lower body portion [2.] The upper portion includes a receptacle [5] with a floor surface defining a plurality of apertures. In the embodiment shown, a first plurality [9a] includes a center aperture and a first circular array of apertures of substantially the same diameter radially spaced away from the center aperture. A second plurality of apertures [9b] is disposed radially between the center and the circular array of the first plurality of apertures. The upper body includes a planar mating surface and two cavities proximate to the bowl rim into which magnets [8] are inserted to be flush with or slightly below the mating plane. The plane and its magnets define a modular accessory connection port.

“Modular” in this specification means that the features and dimensions of an attachment site of a component of the pipe assembly or a detachable accessory component to be used with the pipe assembly share common surface geometries or mating features. A product is “modular” and compatible with this system when there are no unpredictable elements in the arrangement of predetermined locating features for mating or assembling the product components into a larger entity in which all modules fit and work together. “Modularity” in this specification standardizes the way by which components fit and interact together, especially physically and mechanically, such as interfaces between mated planar surfaces and the locations and polar orientations of the magnets used to attract and affix components together. The polar orientations of the magnets may also be used to accept preferred orientations of accessories and to reject non-preferred orientations. The incorporation of magnetically attractable material which is not itself magnetic or magnetized such as ferrous metals may be used to provide accessories affixable at a magnetic site with fewer or no orientational constraints. Magnetic materials may include ferrous materials or rare earths such as neodymium, samarium-cobalt compounds or other lanthanide materials.

The modularity defined by the inventive pipe assembly allows various accessory devices to connect to the pipe bringing more smoking options and amenities to the user. The connection point for the accessories is at the top of the pipe, using the magnets located at the top, or a snug fitting attachment at the top of the bowl using an o-ring, or both of these attachment means. A convenient accessory is a bowl extender shown in FIG. 3A. Another convenient accessory is a cap used to prevent the smoking material from falling out of the bowl when not in use, and to protect unconsumed smoking materials from unwanted moisture or the elements. The cap accessory may include magnets or may include magnetically attractable materials which are not themselves magnetic, such as a decorative steel plate. The accessory connection port may also be used for a grinder or a lighter holder.

The pipe assembly may also include ornamental and aesthetic elements such as decorative grooves around the shank [6a] and around the bowl portions [6b] of the upper and lower body portions. The grooves may also provide utility by affording gripping while disassembling components of the pipe assembly and its accessories.

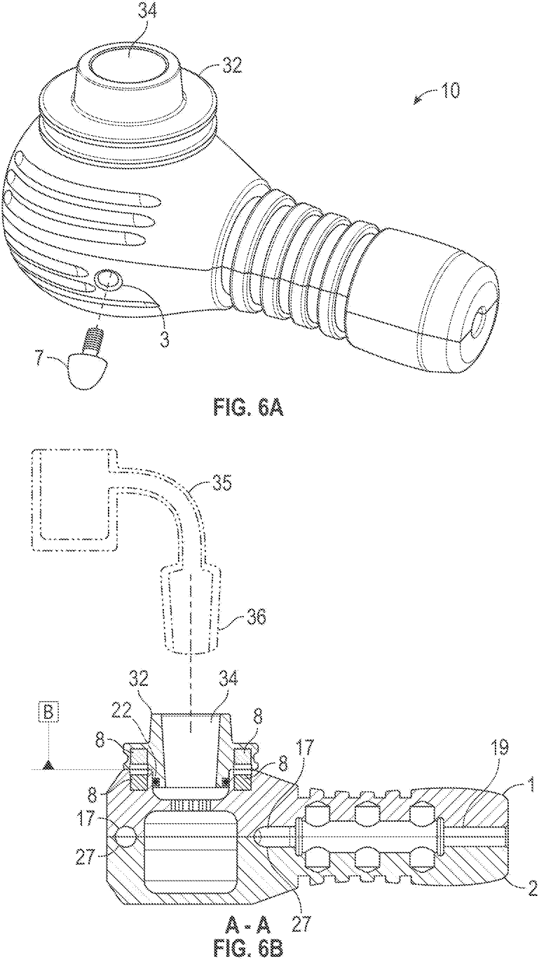

FIG. 2 shows a top view of the smoking pipe of FIG. 1 and defines section line A-A for the cross section views of FIGS. 5A and 6B, and section line B-B for the cross section view of FIG. 5B. The upper surface portion surrounding the receptacle of the upper body portion [1] includes plurality of magnets of which two are visible in this view. Other radial or nonsymmetrical arrangements of magnets at the accessory connection port also reside within the scope of the invention. The upper portion includes a receptacle [5] or bowl having a floor surface defining a plurality of apertures. In aesthetically distinct embodiments of the invention the plurality of apertures include circular holes having a common diameter. In the embodiment shown, a first plurality [9a] includes a circular array of apertures of substantially the same first diameter radially spaced away from the center aperture. A second plurality of apertures [9b] of a second common diameter is disposed radially between a center aperture and the first circular array of the first plurality of apertures. The center aperture [9c] in this embodiment shown is of a third diameter.

FIG. 3A shows an oblique, bottom left rear view of the smoking pipe [10] of FIG. 1 and an accessory which is a bowl extender [15] or “extended bowl attachment” exploded away from its installed position. The interior diameter of the attachment aligns with the bowl of the upper body portion to provide a larger volume for additional smoking material. The extended bowl attachment is an accessory having corresponding magnets; it has two receptacles for magnets [8] pressed in flush or slightly internal to the mating surface so as to be close enough to attract and securely adhere the bowl attachment to the pipe’s magnets. The upper body portion [1] cleaves to the lower body portion [2] by magnetic attraction. The pipe assembly may also include ornamental and aesthetic elements such as decorative grooves around the shank [6a] and around the bowl portions [6b] of the upper and lower body portions.

The lower body portion also includes an aperture [3] which communicates with its internal bowl. This aperture is called a “carb hole” (carburetor) and receives an airflow adjusting device seen in FIGS. 3B and 6A which functions as a throttle to admit an adjustable proportion of air into the smoke stream bowl ahead of the filter while the smoker is drawing on the pipe.

FIG. 3B shows an oblique, top left rear view of the smoking pipe [10] of FIG. 1, with an airflow adjusting device [7] exploded away from a threaded orifice [3] or “carb hole” of the lower body portion [2] into which it is receivable. A bowl extender [31] accessory is also attached to the pipe. This is one of several accessories that may be attached at the accessory connection port that is part of the upper body portion [1] of the pipe.

The adjustable airflow device is threaded into the carb hole to allow the user to vary the amount of air flowing into the chamber in order to draw the smoke from the pipe at a faster or slower rate. It is adjustable from completely closed to completely open to allow outside air into the chamber for slower or faster smoke clearing. The threaded hardware portion of the adjustable airflow device may include an axial passage communicating with one or more lateral apertures in the threaded portion of the device or one or more flutes interrupting the periphery of the threads so that as the device is threaded into the carb hole, less area of the lateral apertures or flutes is exposed to the outside air and thus the inflow into the chamber may be controlled and limited.

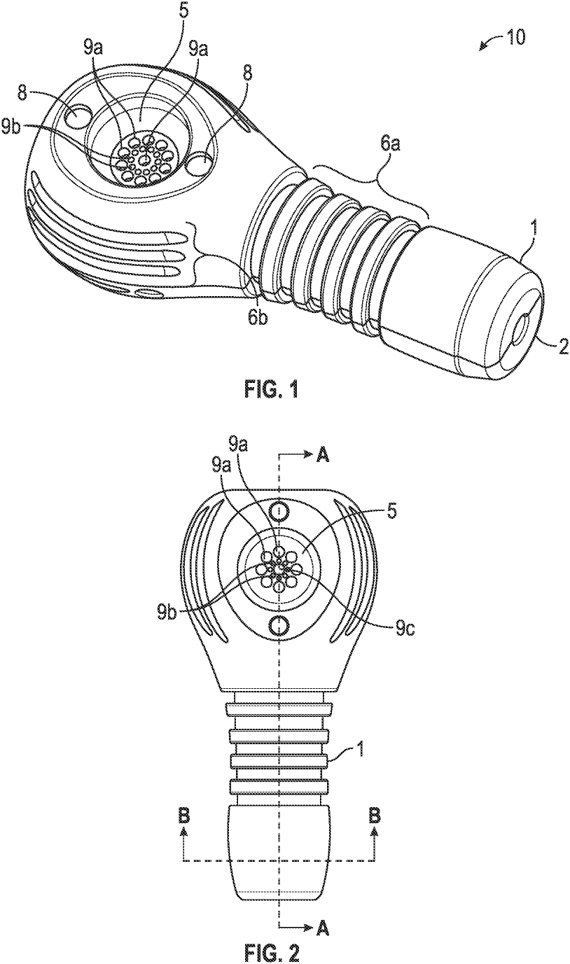

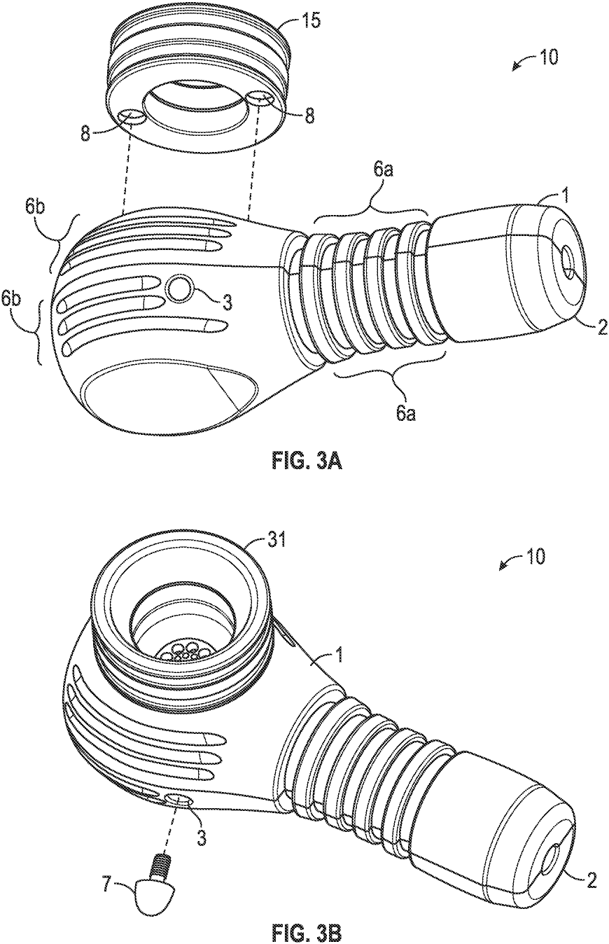

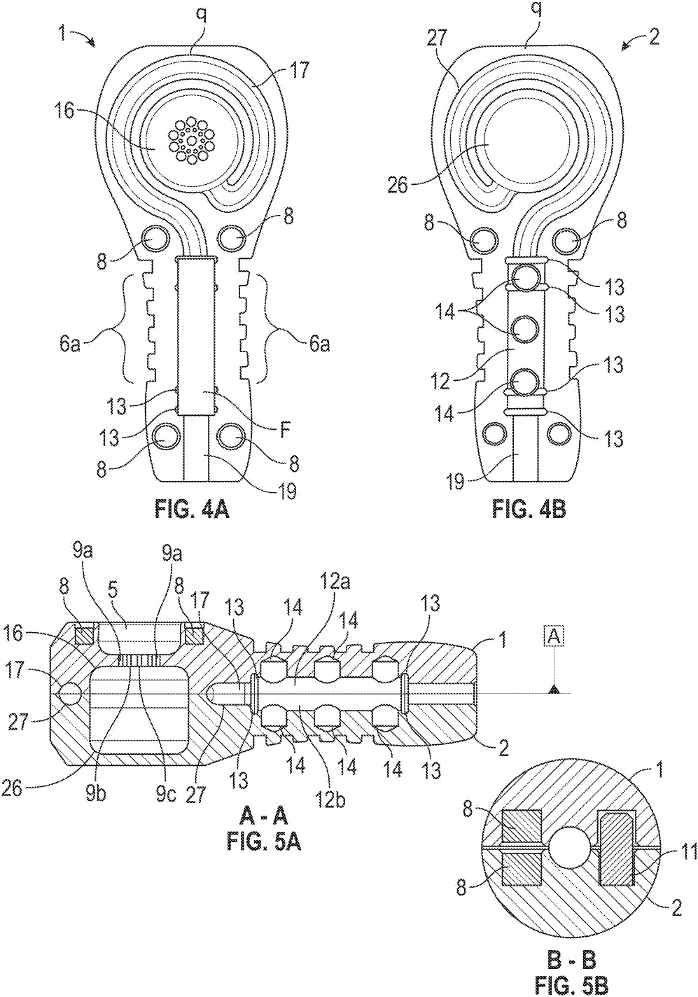

FIG. 4A shows a bottom view of an upper body portion [1] of the smoking pipe of FIG. 1. The lower body portion and the upper body portion define a passage between the smoke chamber and an outlet at the center bottom of this figure where the smoker draws in smoke by mouth. The upper body portion has a cavity [16] which forms a smoke collection chamber beneath the bowl of smoking material. This cavity is complementary with a bowl cavity in the lower body portion. The passage for smoke leaving the bowl to the user includes an arcuate passage [17] which in some preferable embodiments encircles at least half the smoke chamber and in the preferred embodiment shown encompasses the smoke chamber nearly entirely. The passage includes a remote portion [q] away from the outlet on an opposite side of the smoke chamber from the outlet. The opposed portion resides near the top in this figure.

The passage also includes an enlarged portion configured to receive a filter [F] which is shown installed in a upper filter receptacle which is complementary to a corresponding lower filter receptacle in the lower body portion seen in FIG. 4B. This enlarged portion is spaced apart from the outlet by at least a passage segment [19.] Magnets [8] are installed in cavities of the upper body portion so as to be flush or slightly beneath the mating plane which meets the lower body portion. The grip grooves [6a] are visible as castellations along the shank potion of this component. Additional grooves [13] at or near the ends of the filter receptacle provide tooling relief in manufacturing and may admit a prying tool to extricate a filter found to be stuck in the receptacle segment. The magnets of the extended bowl are aligned with the magnets of the connection port to provide a secure connection. The extended bowl is placed atop the connection port and then rotated to align the magnets, which provides resistance to rotation when the bowl is secured.

As seen in previous views, a membrane portion spanning between the bowl cavity and the smoke collection chamber below includes one or more pluralities of apertures which in this embodiment are circular holes, sets of which having a common diameter. The smoke leaving the smoke chamber travels in the designated groove wrapping around the edge of the bowl to dissipate some of the heat before it exits the draw hole at the bottom center of this figure.

FIG. 4B shows a top view of a lower body portion [2] of the smoking pipe of FIG. 1. As with the upper body portion, the lower body portion and the upper body portion define a passage between the smoke chamber and an outlet at the center bottom of this figure where the smoker draws in smoke by mouth. The lower body portion has a cavity [26] which forms a smoke collection chamber beneath the bowl and complementary with the upper portion of the smoke chamber cavity in the upper body portion. The passage for smoke leaving the bowl to the user includes an arcuate passage [27] which in some preferable embodiments encircles at least half the smoke chamber and in the preferred embodiment shown encompasses the smoke chamber nearly entirely. The passage includes a remote portion [q] away from the outlet on an opposite side of the smoke chamber from the outlet. The opposed portion resides near the top in this figure. The radiused channels for the smoke align to form a tube when the two pipe sections are attached. Smoke leaving the chamber takes a long path around the bowl so as to cool before it exits the pipe at the outlet [19] in the bottom center of this figure.

Lengthening the smoke path, either between the smoke chamber to the filter receptacle, or from the filter receptacle to the outlet where the user draws smoke from the pipe, or in both these regions, increases the cooling effect on the smoke by providing more travel time in contact with material which itself is in contact with the ambient environmental temperature. Thus, besides the circuitous path around the bowl including to a remote portion away from the outlet on an opposite side of the smoke chamber from the outlet, other alternative embodiments within the scope of the invention include incorporating other indirect paths such as a serpentine or sinusoidal path, or a path which bifurcates or branches into a plurality of braided paths around certain cooling obstacles before recombining into a single path proximate to the filter receptacle or the pipe outlet, or either or both of these features. Additionally, the cooling obstacles positioned for the smoke to encounter and to transfer heat need not be of the same material as other portions of the pipe body components. Instead, these cooling obstacles and optionally, portions of the walls of the grooves which define the passageways for the smoke may be made of materials having high values of specific heat, heat conductivity, or transmittance. These components may be disposed along the smoke path to act as “chills” and in certain embodiments the raised areas of the pipe components between the decorative grooves are designed to act as heat radiating and dissipating features.

The passage includes an enlarged portion [12] configured to receive a filter, but with the filter removed, ancillary features may also be detailed herein. The enlarged portion is a cylindrical void aligned with the longitudinal aspect of the shank of the pipe and having a diameter greater than the passage. The enlarged portion is a filter receptacle spaced apart from the outlet at the center bottom of this figure by at least a passage segment, so that in normal use a smoker will not contact the filter directly. The ancillary features include additional grooves [13] at or near the ends of the filter receptacle which provide tooling relief in manufacturing and may admit a prying tool to extricate a filter found to be stuck in the receptacle segment, and vaults [14] transverse to the filter receptacle which provide fixturing sites for retaining the component during surface treatments such as plating or powder coating. These features may also be present in the upper body portion.

Grip grooves [6a] are visible as castellations along the shank potion of this component. Magnets [8] are installed in cavities of the lower body portion so as to be flush or slightly beneath the mating plane which meets the upper body portion. The locations of these magnets are complementary to the locations of the magnets in the upper body portion seen in FIG. 4A. The magnetically assembled upper and lower body portions are separable by overcoming the magnetic attractive forces, usually by applying forces transverse to the magnetic fields so as to slide or pivot the body portions with respect to each other so that the attractive force dissipates rapidly as soon as the magnets are no longer aligned. When separated, full access to the internal structures and passages is allowed for cleaning and easy filter replacement. In some preferable embodiments in accordance with the invention, some of the magnets in one body portion may be installed slightly proud of the mating plane and correspond-ing with complementary magnets on the other body portion which are installed slightly below the mating plane so as to provide a tactile detent or “click-in” when the two body portions are assembled and properly aligned.

FIG. 5A shows a cross section view of the conjoined upper and lower body portions of the assembled smoking pipe of FIG. 1 taken at section line A-A defined in FIG. 2. The smoking pipe comprises a lower body portion [2] and an upper body portion [1] removably magnetically connected to the lower body portion. The lower body portion and the upper body portion define an enclosed smoke chamber as aligned cavities [16] of the upper body portion and [26] in the lower body portion. The upper portion defines a receptacle [5] which is a bowl usable for retaining smoking material and having a floor surface which is a perforated membrane unitary with the upper body portion. A plurality of openings communicate through the floor between the receptacle and the smoke chamber which in the embodiment shown include a first plurality [9a] comprising apertures of a first diameter, a second plurality [9b] comprising apertures of a second diameter, and a central aperture [9c] of a third diameter.

The upper body portion has a planar lower surface and the lower body portion has a planar upper surface so that the upper body portion and lower body portion abut each other in a common interface plane [A.] The upper and lower body portions are held together by aligned pairs of magnets [8] on the upper body portion and on the lower body portion, arranged into complementary locations which align each magnet in the upper body with a complementary magnet in the lower body when the bodies are assembled. The upper body portion and lower body portion are operable to detach by sliding on the interface plane. The magnets attaching the upper body to the lower body of the pipe are not seen in this cross section. The magnets shown are part of the accessory connection port which is a modular attachment interface defined at the upper rim of the bowl.

The indirect passage for smoke leaving the smoke chamber is combined from complementary grooves [17] and [27] in the upper and lower bodies as seen and described in FIGS. 4A and 4B. The passage leads from the smoke chamber to an enlarged portion which is a cylindrical void comprised of aligned semi-circular grooves [12a] in the upper body portion and [12b] in the lower body portion and having a diameter greater than the passage to form a pocket cut out in the shank for holding a replaceable filter cartridge. Grooves [13] at the ends of the filter receptacle may be provided for manufacturing relief if required or if more economical. Other vaults [14] transverse to the filter receptacle may be included as necessary or if convenient as fixturing sites for retaining the components during surface treatments such as plating or powder coating. The lower body portion and the upper body portion define a passage between the smoke chamber, the filter receptacle, and an outlet at the right end of the conjoined assembly where the smoker draws in smoke by mouth.

FIG. 5B shows a cross section view of the conjoined upper body portion [1] and lower body portion [2] of the assembled smoking pipe of FIG. 1 taken at section line B-B defined in FIG. 2. The magnets [8] of FIGS. 4A and 4B are seen registered to align with each other. According to some preferred embodiments within the scope of the invention, a cavity in one part may house a pin [11] rather than a magnet, so that the pin tip is received into a complementary cavity in the other part. The pin protrudes beyond the mating surface of the conjoined portions to allow for the one body portion to be pivot ably separated from the other around the magnetic pin. In less preferred embodiments more than one such point may be employed to exclude pivotable separation of the parts and enforce disassembly primarily by prying the two bodies apart.

FIG. 6A shows an oblique, top left rear view of the smoking pipe [10] of FIG. 1 with the airflow adjusting device [7] of FIG. 3B exploded away from the “carb hole” [3] of the lower body portion, and with an adapter [32] for mounting accessories using standardized tapered ground glass joint interconnections such as those found in chemical glassware. The adapter accessory defines a tapered bore [34] configured to receive a tapered accessory. A preferred taper bore is a standard is a 1:10 taper.

FIG. 6B shows a cross section view of the conjoined upper body portion [1] and lower body portion [2] of the assembled smoking pipe of FIG. 1 taken at section line A-A defined in FIG. 2 and also including a glass tube attachment accessory [32] affixed to the accessory connection port atop the upper body portion. The indirect passage for smoke leaving the smoke chamber is combined from complementary grooves [17] and [27] in the upper and lower bodies as seen and described in FIGS. 4A and 4B. The smoke leaving the smoke chamber travels in this designated groove wrapping around the edge of the bowl to dissipate some of the heat before it passes through the filter receptacle spaced apart from the outlet by at least a passage segment [19] and exits the draw hole at the right edge of this figure.

The glass tube attachment accessory includes a tapered orifice [34] configured to receive a complementary tapered accessory. The accessory [35] may be called a “banger” or “nail” and provides a bowl or heating chamber and a conduit which seals against the bowl of the pipe, preferably by means of a ground glass joint having a standard taper [36.] In preferable embodiments the accessory defines a tapered bore configured to receive a tapered accessory and is preferably standardized such as by having a tapered bore which is a 1:10 taper such as those found in chemical glassware.

The upper body portion includes an upper surface portion surrounding the receptacle and including a plurality of magnets [8] configured to retain an accessory having corresponding magnets. The upper surface is planar and the complementary accessory has a lower planar surface including a plurality of corresponding magnets registered with the magnets of the upper surface to define a modular interface at plane [B] which is an accessory connection port. The magnets of the glass tube attachment accessory are aligned with the magnets of the connection port in a secure configuration. The glass tube attachment accessory may be placed atop the connection port and then rotated to align the magnets. The glass tube attachment accessory may also include an o-ring [22] which may provide resistance to rotation when the attachment accessory is secured within the bowl of the upper body portion.

Many modifications and variations may be made to the invention as disclosed herein without departing from its spirit and scope. Thus, although many exemplary embodiments are described above, it will be appreciated that the invention is intended to cover all modifications and equivalents within the scope of the following claims.

I claim:

1. A smoking pipe comprising:
a lower body portion;
an upper body portion removably magnetically connected to the lower body portion;
the lower body portion and the upper body portion defining an enclosed smoke chamber;
the upper portion defining a receptacle;
a plurality of openings communicating between the receptacle and the smoke chamber; and
the lower body portion and the upper body portion defining a passage between the smoke chamber and an outlet.

2. The smoking pipe of claim 1, wherein the upper body portion has a planar lower surface and the lower body portion has a planar upper surface, and wherein the upper body portion and lower body portion abut each other in a common interface plane.

3. The smoking pipe of claim 2, wherein the upper body portion and lower body portion are operable to detach by sliding on the interface plane.

4. The smoking pipe of claim 1, wherein the passage encompasses the smoke chamber.

5. The smoking pipe of claim 1, wherein the passage includes a remote portion away from the outlet on an opposite side of the smoke chamber from the outlet.

6. The smoking pipe of claim 1, wherein the passage is an arcuate passage.

7. The smoking pipe of claim 1, wherein the passage encircles at least half the smoke chamber.

8. The smoking pipe of claim 1, wherein the passage includes an enlarged portion configured to receive a filter.

9. The smoking pipe of claim 8, wherein the enlarged portion is spaced apart from the outlet by at least a passage segment.

10. The smoking pipe of claim 8, wherein the enlarged portion is a cylindrical void having a diameter greater than the passage.

11. The smoking pipe of claim 1, including magnets on the upper body portion and magnets on the lower body portion.

12. The smoking pipe of claim 11, wherein the magnets are registered to align with each other.

13. The smoking pipe of claim 1, including an upper surface portion surrounding the receptacle and including a plurality of magnets configured to retain an accessory having corresponding magnets.

14. The smoking pipe of claim 13, wherein the upper surface is planar.

15. The smoking pipe of claim 13, including an accessory having a lower surface including a plurality of corresponding magnets registered with the magnets of the upper surface.

16. The smoking pipe of claim 13, wherein the accessory defines a tapered bore configured to receive a tapered accessory.

17. The smoking pipe of claim 16, wherein the tapered bore is a 1:10 taper.

18. The smoking pipe of claim 1, wherein the upper portion receptacle has a floor surface defining a plurality of apertures.

19. The smoking pipe of claim 18, wherein the floor surface is unitary with the upper body portion.

20. The smoking pipe of claim 18, wherein the plurality of apertures are circular holes having a common diameter.
